(19) United States
(12) Patent Application Publication
(10) Pub. No.: US 2024/0428165 A1
(43) Pub. Date: Dec. 26, 2024

(54) SIMULATION COMPUTING ENVIRONMENT FOR MULTI-PARTY OPERATIONAL PLANS

(71) Applicant: Wells Fargo Bank, N.A., San Francisco, CA (US)

(72) Inventors: Ryan Hammond, San Francisco, CA (US); Sadie S. Salim, Mill Valley, CA (US); Dennis E. Montenegro, Concord, CA (US); Benjamin Brinkman, Minneapolis, MN (US)

(21) Appl. No.: 18/341,153

(22) Filed: Jun. 26, 2023

(51) Int. Cl. G06Q 10/0637

(52) U.S. Cl. CPC G06Q 10/0637

(57) ABSTRACT

A multi-party operational plan simulation computing system implements a build-simulation module and a staging-simulation module. Based on characteristics of an operational plan, the build-simulation module generates a build plan data object and permits a particular network node to modify the build plan data object. The staging-simulation module simulates an environment for the operational plan and permits multiple network nodes to simulate the build plan data object. Based on data received from the particular network node or a simulation, the multi-party operational plan simulation computing system determines a data value that describes a revised characteristic of the operational plan and modifies the build plan data object based on the revised characteristic. The multi-party operational plan simulation computing system provides, to one or more network nodes, interface data associated with the modified build plan data object.

### TECHNICAL FIELD

This disclosure relates generally to the field of computer-implemented simulation, and more specifically relates to computer simulation of multi-party operational plans.

### BACKGROUND

Computer-implemented simulation of an operational plan can provide valuable information to one or more parties that are affected by the operational plan. Some examples of operational plans can include entrepreneurial plans (such as for start-up companies), business expansion plans, manufacturing logistics plans, or other types of operational plans that involve multiple parties. In some cases, an operational plan is developed by a particular party, such as a business owner, and involves multiple additional parties, such as suppliers, manufacturers, consulting specialists, financing institutions, or other participants (or potential participants) in the operational plan. In addition, an operational plan may be developed by a party with limited resources, such as an entrepreneur who is working to develop a business. In some cases, a party developing an operational plan may have resources (e.g., raw materials, time, financing) that are sufficient for a small number of attempts to fulfill the operational plan, but insufficient for a larger number of attempts. For example, an entrepreneur who is working to start a small business often cannot afford to have an operational plan, such as a business plan, fail more than once (if at all).

It is desirable to develop computer-implemented simulation tools that can accurately simulate multiple scenarios that affect an operational plan. In addition, it is desirable for computer-implemented operational plan simulation tools to have accessible and understandable user interface components that can facilitate high comprehension and participation for multiple parties involved in an operational plan.

### SUMMARY

According to certain embodiments, a multi-party operational plan simulation computing system implements a build-simulation module and a staging-simulation module. The build-simulation module is configured to generate a build plan data object based on characteristics of an operational plan. The staging-simulation module is configured to simulate an environment for the operational plan. The build-simulation module is accessible by a particular network node in a multi-node network. The staging-simulation module is accessible by the particular network node and an additional network node in the multi-node network. In response to receiving simulation request data from the additional network node, the staging-simulation module simulates operation of the operational plan within the simulated environment. Based on the simulated operation or input data received from at least one of the particular network node or the additional network node, the multi-party operational plan simulation computing system determines a data value that describes a revised characteristic of the operational plan. The multi-party operational plan simulation computing system modifies the build plan data object based on the revised characteristic. The multi-party operational plan simulation computing system provides, to the particular network node and the additional network node, interface data that is associated with the modified build plan data object.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of a computing environment in which a multi-party operational plan simulation computing system generates simulation data describing computer-simulated implementation of an operational plan, according to certain embodiments;

FIG. 2 is a diagram depicting an example of a computing environment in which a multi-party operational plan simulation computing system modifies a build plan data object based on multiple data sources, according to certain embodiments;

FIG. 3 is a flow chart depicting an example of a process for performing computer-simulated implementation of an operational plan, according to certain embodiments;

FIG. 4 is a flow chart depicting an example of a process for generating consensus modification data for a revised characteristic associated with computer-simulated implementation of an operational plan, according to certain embodiments; and

FIG. 5 is a diagram depicting an example of a computing system for implementing a multi-party operational plan simulation computing system, according to certain embodiments.

### DETAILED DESCRIPTION

As discussed above, contemporary techniques for simulating an operational plan do not provide computer-implemented simulation tools to coordinate simulations among multiple parties. An operational plan may involve multiple parties, each of which commits to one or more roles for the operational plan, such as entrepreneurial roles, consultant roles, manufacturing roles, ownership roles, financial roles, or other roles for an operational plan. In some cases, multiple parties may desire to access a computer-implemented simulation of the operational plan (or a portion or the plan), such as to receive computer-implemented simulation information about possible outcomes of the operational plan. However, contemporary tools for computer-implemented simulation of an operation plan may be unable to run multiple simulations for an operational plan or modified versions of an operational plan, such as multiple simulations requested by respective parties that are participating in the plan. Thus, contemporary tools for computer-implemented simulation of an operation plan may provide slow or outdated information about a simulation outcome, such as slow or outdated information that does not include the multiple revisions requested by the respective parties.

Certain embodiments described herein provide for a multi-party operational plan simulation computing system that generates simulation information for multiple versions of an operational plan, based on input data describing multiple modifications. The multi-party operational plan simulation computing system can receive the input data from multiple computing systems that are associated with various respective parties that have participating roles in the operational plan being simulated. In some cases, a party participating in an operational plan can benefit from receiving computer-implemented simulation information that accurately and quickly describes potential operational outcomes in multiple simulated scenarios. Benefits of receiving computer-implemented simulation information can include improved communication among multiple parties participating in an operational plan, lower risk of operational plan failure, reduced risk of resource loss (e.g., manufacturing waste, budget overruns, insufficient hiring), increased comprehension of potential operational outcomes, and other types of benefits.

The following examples are provided to introduce certain embodiments of the present disclosure. In the example described here, a multi-party operational plan simulation computing system implements a build-simulation module and a staging-simulation module. The build-simulation module is accessible by a particular network node that is included in (or accessible by) the multi-party operational plan simulation computing system. The staging-simulation module is accessible by the particular network node and multiple additional network nodes that are included in (or accessible by) the multi-party operational plan simulation computing system. Based on input data from the particular network node, the build-simulation module generates a build plan data object that describes an operational plan, such as an entrepreneurial plan that is being developed by a party (e.g., an entrepreneur) associated with the particular network node. In addition, the staging-simulation module receives, from the multiple additional network nodes, simulation request data that indicate modifications to the operational plan described by the build plan data object. The staging-simulation module generates one or more staged build plan data objects, which include one or more of the indicated modifications. Based on the one or more staged build plan data objects, the staging-simulation module performs multiple simulations of the operational plan, including simulations that include the indicated modifications. The staging-simulation module provides simulation results data to the particular network node and the multiple additional network nodes.

Continuing with the above example, the multi-party operational plan simulation computing system receives additional input data from the particular network node and the multiple additional network nodes. The input data describes a proposed modification from each of the network nodes, such as respective proposed modifications developed by respective parties associated with each of the network nodes. The build-simulation module generates consensus modification data based on the respective proposed modifications described by the input data. In some cases, the build-simulation module generates the consensus modification data based on a weighted combination of the respective proposed modifications, such as by applying weights to particular proposed modifications that are provided by network nodes that describe particular participant roles for the operational plan. The build-simulation module modifies the build plan data object based on the consensus modification data. In addition, the staging-simulation module modifies the one or more staged build plan data objects, such as based on a determination that the build plan data object is modified.

Certain embodiments described herein provide improved techniques for simulating a multi-party operational plan. For example, a multi-party operational plan simulation computing system can provide a technical tool that increases access and comprehension for multiple parties who wish to evaluate or participate in an operational plan. In addition, the multi-party operational plan simulation computing system can improve accuracy of simulation data for operational plans, such as by generating simulation data for multiple simulations that include multiple modifications of an operational plan. The multi-party operational plan simulation computing system can also improve coordination among multiple parties that participate in an operational plan, such as by generating consensus modification data that is based on multiple inputs from the multiple parties. In some cases, the multi-party operational plan simulation computing system can utilize particular rules to modify computer-implemented simulations of an operational plan, including rules to determine consensus modifications based on multiple inputs or a combination of multiple inputs received from additional computing systems associated with multiple parties. The utilization of the particular rules can generate new or additional computer-implemented data structures-such as consensus modification data, a build plan data object, or a staged build plan data object-that describe and coordinate modifications to an operational plan with increased accuracy compared to human analysis or contemporary tools for simulating an operational plan.

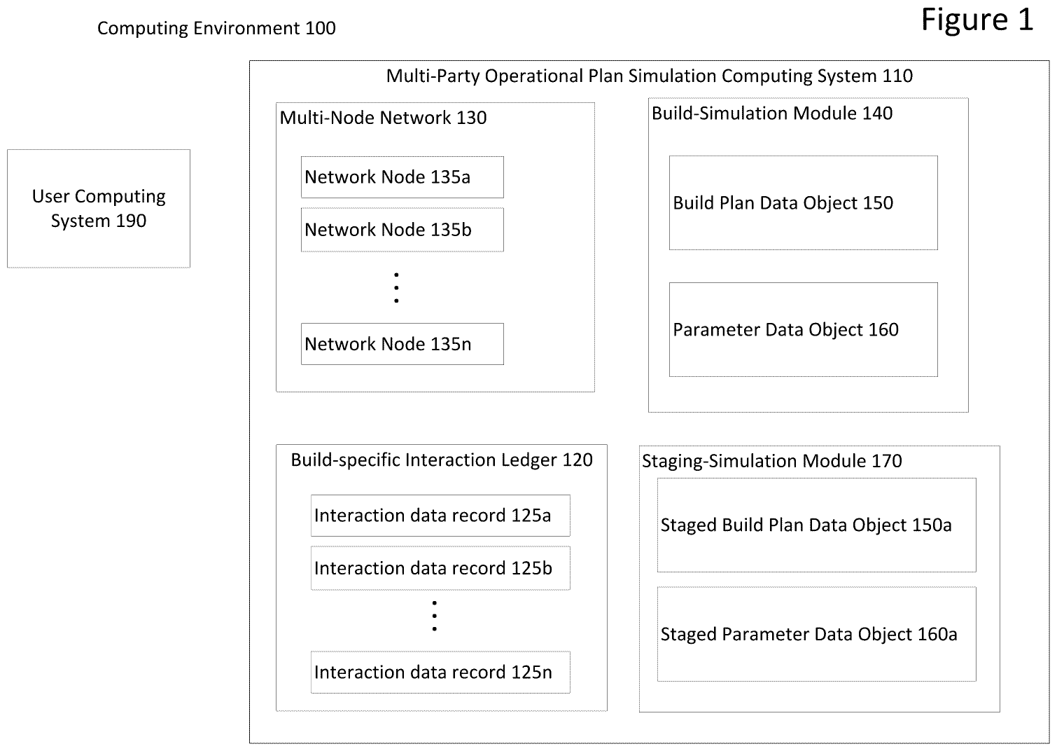

Referring now to the drawings, FIG. 1 is a diagram depicting an example of a computing environment 100, in which a multi-party operational plan simulation computing system 110 generates simulation data describing computer-simulated implementation of an operational plan. Examples of an operational plan can include a business plan (such as an entrepreneurial plan for a new business or an expansion plan for an existing business), a manufacturing logistics plan, a transportation logistics plan, or other types of plans to perform a set of activities. In some cases, the multi-party operational plan simulation computing system 110 generates simulation data that describes computer-simulated implementation of a multi-party operational plan, in which various activities described by the multi-party operational plan are respectively performed by (or on behalf of) multiple parties that participate in the multi-party operational plan. Examples of a party that could participate in an operational plan can include a person, a company, a governmental agency, a financial institution, a non-profit organization, or other types of parties that can perform activities for an operational plan. In some cases, the simulation data generated by the multi-party operational plan simulation computing system 110 can improve real-world (e.g., not computer-simulated) outcomes of the operational plan. For example, the simulation data generated by the multi-party operational plan simulation computing system 110 can provide valuable information to one or more parties about potential real-world outcomes of the operational plan prior to real-world implementation. In addition, the operational plan can be modified by the multi-party operational plan simulation computing system 110 based on the generated simulation data, such as iterative cycles of modification and simulation of the operational plan. In some cases, the multi-party operational plan simulation computing system 110 can improve implementation of the operational plan, reduce resource loss (e.g., raw material loss, financial loss, time loss), increase efficiency for human efforts during implementation, or provide other improvements for one or more parties involved in implementing the operational plan.

The computing environment 100 can include the multi-party operational plan simulation computing system 110 and one or more user computing systems, such as a user computing system 190. In addition, the multi-party operational plan simulation computing system 110 can include one or more of a multi-node network 130, a build-simulation module 140, or a staging-simulation module 170. The multi-party operational plan simulation computing system 110 can be configured to exchange data with the user computing system 190 (or one or more additional computing systems), such as data transmitted via one or more computing networks (e.g., local-area networks, wide-area networks, mobile data networks).

The multi-node network 130 can include one or more network nodes, such as a network node 135a, a network node 135b, up through a network node 135n. Each of the network nodes 135a through 135n can be associated with a respective party, such as parties that might participate in an operational plan that is simulated by the multi-party operational plan simulation computing system 110. For example, each of the network nodes 135a through 135n can include data describing one or more of a user profile for the respective party, access privileges associated with the respective party, login data or other security-related information for the respective party, or other data that is associated with the respective party. In some cases, each of the network nodes 135a through 135n can include data that describes one or more roles of the respective party, such as data indicating if the respective party is one or more of an entrepreneur, a supplier, a manufacturer, a financing group, a consultant, or another role that can implement an activity described by an operational plan. In addition, each of the network nodes 135a through 135n can be associated with a respective additional computing system, such as a particular user computing system that can access the associated network node (e.g., via an application programming interface of the multi-party operational plan simulation computing system 110). For example, the network node 135a can be associated with the user computing system 190, such that a user of the user computing system 190 could access one or more functions of the multi-party operational plan simulation computing system 110 via the network node 135a. In the computing environment 100, the multi-node network 130 can be configured as a many-to-many graph network, in which each of the network nodes 135a through 135n has a network relationship with at least one additional node in the multi-node network 130. In addition, the multi-party operational plan simulation computing system 110 can provide one or more computer-implemented interaction functions for network nodes in the multi-node network 130, such as interaction functions for node-to-node communication, data transfer for simulation data or other data, commitment updates (e.g., a proposed update for an operational plan is committed to a build plan data object associated with the operational plan), or other types of interactions among two or more network nodes within the multi-node network 130.

In the multi-party operational plan simulation computing system 110, each of the network nodes 135a through 135n can be associated with a respective build-simulation module included in the multi-party operational plan simulation computing system 110. For example, the network node 135a is associated with a build-simulation module 140 that is included in the multi-party operational plan simulation computing system 110. The build-simulation module 140 can be a component of the multi-party operational plan simulation computing system 110, such as a virtual software module implemented within the multi-party operational plan simulation computing system 110. In some cases, the multi-party operational plan simulation computing system 110 can implement the respective build-simulation modules for each of the networks nodes 135a through 135n. In addition, the multi-party operational plan simulation computing system 110 can implement a particular respective build-simulation module based on an input associated with a particular network node, such as generating the build-simulation module 140 in response to request data associated with the network node 135a. For example, the multi-party operational plan simulation computing system 110 could receive, from the user computing system 190, request data that requests instantiation of or access to the build-simulation module 140. In response to receiving the request data from the user computing system 190, e.g., via the network node 135a, the multi-party operational plan simulation computing system 110 could generate the build-simulation module 140 for the network node 135a that is associated with the user computer system 190. In some cases, the multi-party operational plan simulation computing system 110 generates a particular build-simulation module based on data that is included in (or otherwise associated with) the respective network node. For example, the multi-party operational plan simulation computing system 110 could generate the build-simulation module 140 based on permissions data associated with the network node 135a. Based on the permissions data, the build-simulation module 140 could provide the network node 135a with access to a set (or subset) of computer-implemented build functions implemented by the multi-party operational plan simulation computing system 110, such as build functions for generating or modifying data objects that can be simulated by the staging-simulation module 170. As an example, responsive to determining that the network node 135a includes data describing an entrepreneurial role, the multi-party operational plan simulation computing system 110 could identify permissions data that describes a subset of the computer-implemented build functions related to generating entrepreneurial operational plans. As another example, responsive to determining that the network node 135a includes user profile data describing relatively low level of experience (e.g., a new user), the multi-party operational plan simulation computing system 110 could identify permissions data that describes an additional subset of the computer-implemented build functions related to simplified generation of operational plans (e.g., a reduced set of tools for the new user).

In FIG. 1, the build-simulation module 140 (or additional build-simulation modules associated with additional network nodes in the multi-node network 130) can be configured to generate one or more data objects that can be simulated within the multi-party operational plan simulation computing system 110, such as simulation by the staging-simulation module 170. For example, the build-simulation module 140 can generate (e.g., via the subset of computer-implemented build functions) one or more of a build plan data object 150 or a parameter data object 160. Based on the generation by the build-simulation module 140, one or more of the build plan data object 150 or the parameter data object 160 can be associated with the network node 135a. The build plan data object 150 can include data that describes an operational plan, such as one or more data values that indicate characteristics of the operational plan. In addition, the parameter data object 160 can include data that describes a simulation environment in which the operational plan described by the build plan data object 150 can be simulated, such as parameter data that describes simulation environment characteristics. FIG. 1 describes the network node 135a as being associated with the data objects 150 and 160 via the build-simulation module 140, but other configurations are possible. For example, a particular network node could access build functions of a particular build-simulation module (or multiple build-simulation modules associated with the particular network node) to generate multiple build plan data objects and associated parameter data objects, such as multiple build plan data objects that respectively describe different operational plans (e.g., for different entrepreneurial efforts) or different variations of a particular operational plan (e.g., different approaches for a particular entrepreneurial effort).

In some cases, the build-simulation module 140 generates one or more of the build plan data object 150 or the parameter data object 160 based on inputs received via the associated network node 135a. For example, the network node 135a could receive, from the user computing system 190, input data that describes one or more characteristics of an operational plan, such as a multi-party operational plan that is being developed by a user of the user computing system 190. The input data may be received via a user interface of the user computing system 190, such as user interface implemented via a display device, a touchscreen, voice-recognition software, a haptic feedback device (e.g., Braille reader), or other suitable technique for presenting a user interface. In some cases, the network node 135a accesses one or more of the computer-implemented build functions (e.g., permitted by the build-simulation module 140) to provide the input data or performs other actions to generate or modify the build plan data object 150 or the parameter data object 160. In addition, the build-simulation module 140 could extract, from the input data, data values describing the operational plan characteristics or the simulation environment characteristics. Examples of operational plan characteristics or the simulation environment characteristics described by extracted data values can include a type of operational plan, a geographical region for implementation, a geographical region for distribution, a level of expertise (e.g., for a party involved in the operational plan), a regulatory jurisdiction, a product development timeline, or other characteristics for an operational plan or a simulation environment. In some cases, the build-simulation module 140 generates or modifies one or more of the build plan data object 150 or the parameter data object 160 based on the extracted characteristic data values. As an example, the build-simulation module 140 could extract characteristic data that describes a manufacturing operational plan. Responsive to determining that the characteristic data indicates a manufacturing operational plan, the build-simulation module 140 can modify the build plan data object 150 to include data values describing the manufacturing plan, such as operational plan characteristics for production schedules, costs for raw materials, shipping schedules, or other factors that could affect a manufacturing operational plan. In addition, responsive to determining that the characteristic data indicates a manufacturing operational plan, the build-simulation module 140 can modify the parameter data object 160 to include parameter data that describes a simulation environment for manufacturing, such as simulation environment characteristics for availability of raw material, equipment capacity, labor availability, or other factors that could affect a manufacturing environment (e.g., a real-world manufacturing environment).

In the multi-party operational plan simulation computing system 110, one or more of the build plan data object 150 or the parameter data object 160 is associated with the network node 135a, based on a determination that the build-simulation module 140 is associated with the network node 135a. In addition, one or more of the build plan data object 150 or the parameter data object 160 can be associated with at least one additional network node in the multi-node network 130, based on a determination that a party represented by the additional network node has committed to a portion of the operational plan described by the build plan data object 150. For example, the network node 135b could be associated with a first party that has an entrepreneurial role, such as a small business owner. In addition, the network node 135b could be associated with a party that has a manufacturing role, such as an owner of a production facility. In some cases, the second party could commit to performing a portion of the operational plan described by the build plan data object 150, such as completing a production run of a product described by the build plan data object 150. The multi-party operational plan simulation computing system 110 can receive or generate data (e.g., via a computer-implemented interaction function for the network nodes in the multi-node network 130) indicating that the network node 135b includes data describing a participant role for the build plan data object 150. For example, the participant role could indicate that the network node 135b is associated with a party that has committed to implementing a portion of the operational plan described by the build plan data object 150. Responsive to determining that the network node 135b indicates the participant role for the operational plan described by the build plan data object 150, the multi-party operational plan simulation computing system 110 can associate the network node 135b with the build plan data object 150. In addition, responsive to determining that the network node 135b indicates the participant role, the build-simulation module 140 could provide the network node 135b with access to a set (or subset) of the computer-implemented build functions implemented by the multi-party operational plan simulation computing system 110, such as a subset of build functions for generating or modifying manufacturing-related characteristic data or parameter data in the data objects 150 or 160. In some cases, the multi-party operational plan simulation computing system 110 could revoke a participant role, such as in response to determining that the network node 135b no longer includes data describing the participant role. In addition, responsive to determining that the network node 135b no longer describes the participant role, the build-simulation module 140 could revoke access to the subset of build functions for generating or modifying data in the data objects 150 or 160.

In FIG. 1, the staging-simulation module 170 can be configured to simulate one or more build plan data objects that are generated by the build-simulation module 140 (or additional build-simulation modules included in the multi-party operational plan simulation computing system 110). For example, the staging-simulation module 170 can simulate the build plan data object 150 based on simulation environment characteristics described in the parameter data object 160. In some cases, the multi-party operational plan simulation computing system 110 can provide one or more computer-implemented simulation functions for the staging-simulation module 170, such as simulation functions for running a simulation, adjusting parameter data for a simulation, generating output data summarizing or otherwise describing a simulation, generating alert data describing a simulation, or other types of simulation activities by the staging-simulation module 170. In some cases, the staging-simulation module 170 can permit one or more of the network nodes in the multi-node network 130 access to the computer-implemented simulation functions, such as for simulating a particular build plan data object associated with a particular network node. In addition, the staging-simulation module 170 can provide shared simulation of a particular build plan data object, such as by permitting multiple network nodes in the multi-node network 130 to simulate the particular build plan data object. For example, the staging-simulation module 170 could identify, in the build plan data object 150 or the parameter data object 160, availability data indicating that the build plan data object 150 is available for simulation by any network node in the multi-node network 130. Based on the identification of the data indicating that the build plan data object 150 is available for simulation by any network node, the staging-simulation module 170 can permit simulation of the build plan data object 150 in response to receiving a simulation request from any of the network nodes 135a through 135n. In addition, the staging-simulation module 170 could identify, in the build plan data object 150 or the parameter data object 160, availability data indicating that simulation results (e.g., output data describing a simulation) for the build plan data object 150 are available for viewing by any network node in the multi-node network 130. Based on the identification of the availability data indicating that the simulation results are available for viewing by any network node, the staging-simulation module 170 can permit any of the network nodes 135a through 135n to view simulation results of the build plan data object 150, such as in response to receiving a viewing request from a particular network node.

In some cases, the staging-simulation module 170 can identify, in the build plan data object 150 or the parameter data object 160, availability data indicating that the build plan data object 150 is available for simulation, or that simulation results are available for viewing, by a subset of the network nodes in the multi-node network 130. In addition, the staging-simulation module 170 could identify the subset of network nodes based on a determination that the availability data indicates a characteristic described by one or more network nodes, such as a role of an associated party (e.g., a manufacturing-related role), a geographical region, an expertise level for an associated party (e.g., five or more years of experience in software development), or other characteristics that can be described by data in a network node. For example, the staging-simulation module 170 could identify, in the build plan data object 150, availability data indicating that the build plan data object 150 is available for simulation by network nodes having a manufacturing role. In addition, the staging-simulation module 170 could receive, from the network node 135b and the network node 135n, respective simulation requests to simulate the build plan data object 150. Responsive to determining that the network node 135b includes data indicating a manufacturing role, the staging-simulation module 170 could permit the network node 135b to simulate the build plan data object 150. In addition, responsive to determining that the network node 135n omits data indicating a manufacturing role, the staging-simulation module 170 could deny the network node 135n access to simulating the build plan data object 150

In FIG. 1, one or more of the network nodes in the multi-node network 130 can simulate a particular build plan data object within the staging-simulation module 170. In addition, one or more of the network nodes in the multi-node network 130 can modify a simulation of the particular build plan data object in the staging-simulation module 170. In some cases, the staging-simulation module 170 can identify availability data indicating that the particular build plan data object is available for simulation or modified simulation by a subset of the network nodes in the multi-node network 130. In some cases, the staging-simulation module 170 simulates the build plan data object 150 or modifies a simulation of the build plan data object 150 using an additional version of the build plan data object 150, such as a staged build plan data object 150a. In some cases, the simulation or modified simulation can be performed using an additional version of the parameter data object 160, such as a staged parameter data object 160a. The staging-simulation module 170 could generate one or more of the staged build plan data object 150a or the staged parameter data object 160a as, for example, local copies of the build plan data object 150 or parameter data object 160, such as copied data objects that are utilized by the staging-simulation module 170 instead of the original data objects 150 or 160. The staging-simulation module 170 can modify one or more of the staged build plan data object 150a or the staged parameter data object 160a based on simulation request data received from one or more of the network nodes in the multi-node network 130. The build plan data object 150 or the parameter data object 160 can be unmodified by the simulation request data, e.g., are not affected by a modification described by the simulation request data. For example, the staging-simulation module 170 could receive, from the network node 135b, a simulation request that describes a modification to a data value in the staged build plan data object 150a, such as a modification to a characteristic of the operational plan described by the staged build plan data object 150a. Based on the simulation request from the network node 135b, the staging-simulation module 170 could simulate the modified version of the staged build plan data object 150a, such as a simulation of the modified operational plan characteristic. In addition, the staging-simulation module 170 could receive, from the network node 135a, a simulation request that describes a modification to a parameter value in the staged parameter data object 160a. Based on the simulation request from the network node 135a, the staging-simulation module 170 could simulate the staged build plan data object 150a (or the modified version thereof) using the modified version of the staged parameter data object 160a. In some cases, the staging-simulation module 170 could perform multiple simulations of a particular staged build plan data object based on simulation requests from multiple network nodes in the multi-node network 130, including simulation requests that describe multiple modifications to one or more of the particular staged build plan data object or an associated staged parameter data object. FIG. 1 describes the staging-simulation module 170 as performing multiple modification and/or simulations of the staged build plan data object 150a and the staged parameter data object 160a, but other configurations are possible. For example, an staging-simulation module could generate multiple staged build plan data objects for a particular build plan data object or multiple staged parameter data objects for a particular parameter data object. In this example, the staging-simulation module could generate the multiple staged build plan data objects (or staged parameter data objects) for respective use by particular network nodes, such as a particular staged build plan data object and staged parameter data object for simulations or modified simulations requested by a particular network node. Further in this example, the staging-simulation module could generate the multiple staged build plan data objects (or staged parameter data objects) for respective use by a set or subset of multiple network nodes, such as a particular staged build plan data object and staged parameter data object for simulations or modified simulations requested by multiple network nodes included in a particular subset of network nodes.

In the multi-party operational plan simulation computing system 110, the staging-simulation module 170 can provide simulation results for a particular build plan data object (or one or more associated staged build plan data objects). The simulation results can be accessible by one or more network nodes in the multi-node network 130. In some cases, the staging-simulation module 170 can identify availability data indicating that simulation results for the particular build plan data object are available for viewing by a subset of the network nodes in the multi-node network 130. In some cases, the staging-simulation module 170 can provide simulation results for some or all simulations of the particular build plan data object, including simulations that modify a staged version the particular build plan data object or an associated staged parameter data object. For example, the staging-simulation module 170 could receive, from at least one of the network nodes 135a through 135n, a request to view one or more simulation results of the build plan data object 150, e.g., simulations performed using the associated staged build plan data object 150a. In some cases, the request could indicate a characteristic of the requested simulations. Examples of a requested simulation characteristic could include simulations that were requested by network nodes having a particular role (e.g., simulations requested by network nodes having a manufacturing role), simulations that were modified, simulations that were modified for a particular data value or data value range (e.g., all simulations that modified a projected shipping schedule within a particular time range), simulations that resulted in a particular outcome (e.g., success of the simulated operational plan, failure of the simulated operational plan), or additional simulation characteristics. Based on the request to view the simulation results, the staging-simulation module 170 could provide or otherwise permit access to simulation results of the associated staged build plan data object 150a, such as permitting access by the requesting network node. In some case, the staging-simulation module 170 (or another component of the multi-party operational plan simulation computing system 110) generates visualization data that describes the requested simulation results, such as visualization data that provides the simulation results for presentation via a suitable user interface. Examples of visualization data can include data intended for presentation via a visual display device, an audio device, a tactile or haptic device (e.g., a Braille reader), a virtual reality environment, or other forms of presentation suitable for various user interface types.

In some cases, the multi-party operational plan simulation computing system 110 can include a build-specific interaction ledger 120. The build-specific interaction ledger 120 can be associated with the build plan data object 150. In some cases, the multi-party operational plan simulation computing system 110 can include one or more additional build-specific interaction ledgers, each of which is respectively associated with a particular additional build plan data object included in the multi-party operational plan simulation computing system 110. The build-specific interaction ledger 120 can include one or more data records, such as an interaction data record 125a, an interaction data record 125b, up through an interaction data record 125n. The interaction data records 125a through 125n can describe interactions with the build plan data object 150, such as interactions via one or more of the computer-implemented interaction functions for the network nodes in the multi-node network 130. Examples of interactions recorded in the build-specific interaction ledger 120 can include modifications, simulations, access requests (e.g., requests to view, requests to modify, requests to simulate), providing or revoking a participant relationship (e.g., a contract or other commitment by a particular party to implement a particular portion of the operational plan described by the build plan data object 150), or other types of interactions with the build plan data object 150. In some cases, the multi-party operational plan simulation computing system 110 may provide view access of the build-specific interaction ledger 120 for each network node in the multi-node network 130, such as view access for a particular network node that requests permission to view one or more of the interaction data records 125a through 125n. In some cases, the multi-party operational plan simulation computing system 110 may provide modification access of the build-specific interaction ledger 120 to one or more particular network nodes based on a determination that the particular network node is associated with the build plan data object 150 (or the build-simulation module 140 in which the build plan data object 150 is generated). For example, the multi-party operational plan simulation computing system 110 may provide modification access of the build-specific interaction ledger 120 to the network node 135a based on a determination that the network node 135a is associated with the build plan data object 150. In addition, based on a determination that the build plan data object 150 is modified to include an association with an additional network node, the multi-party operational plan simulation computing system 110 may provide modification access of the build-specific interaction ledger 120 to the additional network node. For example, the multi-party operational plan simulation computing system 110 may provide modification access of the build-specific interaction ledger 120 to the network node 135b based on a determination that the network node 135b indicates a participant role for the build plan data object 150. In some cases, the multi-party operational plan simulation computing system 110 can modify the build-specific interaction ledger 120 based on data received from an additional computing system, such as data indicating a commitment by a particular party associated with the additional computing system, a real-world implementation of a portion of the operational plan described by the build plan data object 150, or other types of updates provided by the additional computing system. In addition, the multi-party operational plan simulation computing system 110 can update a simulation of the build plan data object 150 based on the data received from an additional computing system, such as by modifying one or more of the data objects 150, 160, 150a, or 160a to indicate the example commitment, example real-world implementation of the portion, or other example update types. In FIG. 1, the build-specific interaction ledger 120 is configured as a distributed trust ledger (e.g., a blockchain), but other configurations are possible, such as a build-specific interaction ledger configured as a database or another type of computer-implemented record. In FIG. 1, the build-specific interaction ledger 120 is implemented within the multi-party operational plan simulation computing system 110, but other configurations are possible, such as a multi-party operational plan simulation computing system that is configured to access a build-specific interaction ledger implemented via an additional computing system.

In some cases, a multi-party operational plan simulation computing system can generate simulation results data, interruption data, revision data, or other types of data that provide information about one or more computer-implemented simulations performed by (or otherwise associated with) the multi-party operational plan simulation computing system. In addition, the simulation information data can be generated based on inputs received from multiple nodes included in an multi-node network of the multi-party operational plan simulation computing system. For example, the multi-party operational plan simulation computing system can provide for simulation a build plan data object that is associated with a first node in an multi-node network. In addition, the multi-party operational plan simulation computing system can receive, from a second node in the multi-node network, simulation request data for simulating the build plan data object. Based on the simulation, the multi-party operational plan simulation computing system can generate simulation information data describing the simulation. In addition, the multi-party operational plan simulation computing system can generate revision data describing one or more proposed modifications to the build plan data object, based on the simulation information data. For example, if an output of the simulation included interruption data describing a fault (e.g., a simulated failure) of the build plan data object, the multi-party operational plan simulation computing system could generate revision data describing a proposed modification to the build plan data object, such as a modification that might avoid or reduce impact of the fault during an additional simulation of the modified build plan data object.

In some cases, a multi-party operational plan simulation computing system can provide revised characteristic data to one or more network nodes having a participant role for a particular build plan data object. The revised characteristic data could be based on revision data, such as revision data that is based on simulation information data for the particular build plan data object. In addition, the multi-party operational plan simulation computing system can generate the revised characteristic data based on input data describing modifications to the particular build plan data object, such as input data received from multiple network nodes. In some cases, the input data from the multiple network nodes can describe multiple modifications that are similar, partly similar, or different. In addition, the multi-party operational plan simulation computing system could generate data based on a consensus modification for the particular build plan data object, such as consensus modification data. The multi-party operational plan simulation computing system can determine the consensus modification data based on a combination of selection data received from one or more network nodes having a participant role for the particular build plan data object.

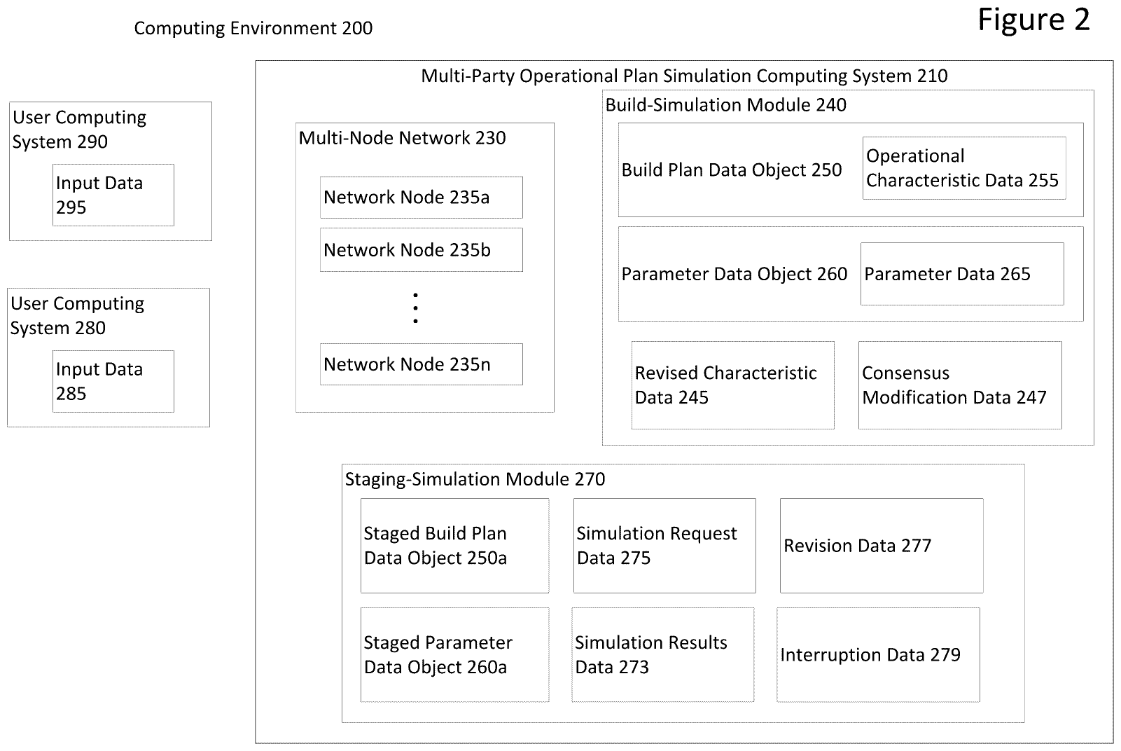

FIG. 2 is a diagram depicting an example of a computing environment 200 in which a multi-party operational plan simulation computing system 210 can modify one or more build plan data objects based on multiple data sources, such as input data from additional computing systems or simulation data describing computer-implemented simulations of the build plan data objects. The computing environment 200 can include the multi-party operational plan simulation computing system 210 and one or more user computing systems, such as a user computing system 290 and a user computing system 280. In addition, the multi-party operational plan simulation computing system 210 can include one or more of a multi-node network 230, at least one build-simulation module such as a build-simulation module 240, or a staging-simulation module 270. The multi-party operational plan simulation computing system 210 can provide one or more computer-implemented functions as generally described in regard to FIG. 1, such as computer-implemented interaction functions for network nodes included in the multi-node network 230, computer-implemented build functions for the build-simulation module 240, or computer-implemented simulation functions for the staging-simulation module 270.

In FIG. 2, the multi-node network 230 can include one or more network nodes, such as a network node 235a, a network node 235b, up through a network node 235n. Each of the network nodes 235a through 235n can be associated with a respective party or include data describing the respective party, such as generally described in regard to FIG. 1. In the computing environment 200, the network node 235a can be associated with the user computing system 290. In addition, the network node 235b can be associated with the user computing system 280.

In the multi-party operational plan simulation computing system 210, each of the network nodes 235a through 235n can be associated with a respective build-simulation module in the multi-party operational plan simulation computing system 210. For example, the network node 235a can be associated with the build-simulation module 240. In addition, the build-simulation module 240 could provide the network node 235a with access to a corresponding set (or subset) of computer-implemented build functions implemented by the multi-party operational plan simulation computing system 210. In some cases, the multi-party operational plan simulation computing system 210 could control access to the build-simulation module 240 and the corresponding set (or subset) of build functions, such as providing access to the associated network node 235a and denying access by one or more additional network nodes in the multi-node network 230.

In FIG. 2, the build-simulation module 240 (or additional build-simulation modules associated with additional network nodes in the multi-node network 230) can be configured to generate one or more data objects that can be simulated within the multi-party operational plan simulation computing system 210, such as simulation by the staging-simulation module 270. For example, the build-simulation module 240 can generate a build plan data object 250 and a parameter data object 260 that are associated with the network node 235a. The build plan data object 250 can describe an operational plan, such as an operational plan being developed by the party associated with the network node 235a. For example, the build plan data object 250 can include one or more data values describing operational characteristics of the operational plan, such as operational characteristic data 255. In addition, the parameter data object 260 can describe a simulation environment for the operational plan described by the build plan data object 250. For example, the parameter data object 260 can include one or more data values describing simulation environment characteristics, such as parameter data 265. In some cases, the multi-party operational plan simulation computing system 210 could control access to one of more of the build plan data object 250, the operational characteristic data 255, the parameter data object 260, or the parameter data 265. In some cases, the build-simulation module 240 controls access based on a determination of whether a particular network node in the multi-node network 230 has a participant role for one of more of the build plan data object 250, the operational characteristic data 255, the parameter data object 260, or the parameter data 265. For example, the build-simulation module 240 could allow access by the network node 235a and the network node 235b, based on a determination by the build-simulation module 240 that the network node 235a has a first participant role (e.g., an ownership role, an entrepreneurial role) for the build plan data object 250 and the network node 235b has a second participant role (e.g., a consultant role, a financing role) for the build plan data object 250. In addition, the build-simulation module 240 could deny access by the network node 235n and one or more additional network nodes in the multi-node network 230, based on a determination by the build-simulation module 240 that the network node 235n and the one or more additional network nodes do not have participant roles for the build plan data object 250.

In FIG. 2, the staging-simulation module 270 can be configured to simulate one or more build plan data objects that are generated by the build-simulation module 240 (or additional build-simulation modules included in the multi-party operational plan simulation computing system 210), such as simulating the build plan data object 250 based on simulation environment characteristics described in the parameter data object 260. The staging-simulation module 270 can include additional versions of the data objects 250 or 260, such as local copies of the data objects 250 or 260. For example, the staging-simulation module 270 can include a staged build plan data object 250a that is an additional data object based on the build plan data object 250. In addition, the staging-simulation module 270 can include a staged parameter data object 260a that is an additional data object based on the parameter data object 260. In some cases, the staging-simulation module 270 can provide simulation access for one or more of the network nodes in the multi-node network 230, such as simulation access for simulating the staged build plan data object 250a (or the build plan data object 250). In addition, the staging-simulation module 270 can provide shared simulation of the staged build plan data object 250a, such as by permitting multiple network nodes in the multi-node network 230 to simulate the staged build plan data object 250a. In some cases, the staging-simulation module 270 provides simulation access (or shared simulation access) based on a determination that the build plan data object 250 or the parameter data object 260 (or the staged data objects 250a or 260a) include availability data indicating that the build plan data object 250 is available for simulation.

In the multi-party operational plan simulation computing system 210, the staging-simulation module 270 receives simulation request data 275 from a network node that is not associated with the staged build plan data object 250a, such as the network node 235n. For example, the staging-simulation module 270 can identify that the network node 235n is not associated with the staged build plan data object 250a based on a determination that the build plan data object 250 (or the staged build plan data object 250a) does not describe a participant role of the network node 235n. In addition, the staging-simulation module 270 determines that the simulation request data 275 describes a request to perform a modified simulation of the staged build plan data object 250a, such as a simulation based on a modified data value in one or more of the staged build plan data object 250a or the staged parameter data object 260a. Based on the simulation request data 275, the staging-simulation module 270 modifies one or more of the staged data objects 250a or 260a, such as by generating an additional copy that includes the requested modification. In response to receiving the simulation request data 275, the staging-simulation module 270 can simulate the staged build plan data object 250a, including a requested modification to the staged build plan data object 250a (or staged parameter data object 260a).

In some cases, the staging-simulation module 270 generates one or more types of simulation information data that describe simulation of the staged build plan data object 250a. The staging-simulation module 270 can generate the simulation information data based on a simulation of the staged build plan data object 250a, a modification of the staged build plan data object 250a (or staged parameter data object 260a), or a combination of multiple modifications of the staged build plan data object 250a (or staged parameter data object 260a). For example, the staging-simulation module 270 could generate simulation results data 273 based on a simulation as described by the simulation request data 275. In some cases, the simulation results data 273 could describe one or more of simulation outcomes, data values included in the staged data objects 250a or 260a, a modified data value in the staged data objects 250a or 260a, or other types of data describing the performed simulation. In addition, the simulation results data 273 could describe a comparison of simulations, such as a comparison of a simulation based on unmodified versions of the staged data objects 250a and 260a with an additional simulation based on modified versions of the staged data objects 250a and 260a, or a comparison of multiple simulations based on multiple modified versions of the staged data objects 250a and 260a.

In addition, staging-simulation module 270 could generate simulation information data that describes one or more interruptions in the requested simulation of the staged build plan data object 250a, such as interruption data 279. In some cases, the interruption data 279 describes expected interruptions in the simulation, such as an interruption indicating a potential success in the operational plan described by the staged build plan data object 250a (e.g., simulation of five years of operation, simulation of operation until 100,000 units sold). In some cases, the interruption data 279 describes unexpected interruptions in the simulation, such as an interruption indicating a potential failure in the operational plan described by the staged build plan data object 250a (e.g., simulation of operation until raw materials are exhausted). For convenience and not by way of limitation, an expected interruption in a simulation may be referred to as a halt and an unexpected interruption in a simulation may be referred to as a fault, but other phrasing may be used.

In the multi-party operational plan simulation computing system 210, the staging-simulation module 270 can generate data that describes a potential revision to the build plan data object 250 or the parameter data object 260, such as revision data 277. For example, the revision data 277 could include a first data value based on a revised operational characteristic of the operational plan described by the staged build plan data object 250a. In addition, the revision data 277 could include an a second data value based on a revised simulation characteristic of the simulation environment described by the staged parameter data object 260a. In some cases, the revision data 277 can be generated based on one or more simulations of the staged build plan data object 250a (or modified versions of the staged build plan data object 250a). In addition, the revision data 277 can be generated based on data provided by one or more of the network nodes in the multi-node network 230, such as the modified data value described by the simulation request data 275. For example, the staging-simulation module 270 could perform a first simulation of the staged build plan data object 250a based on a first modified data value described by the simulation request data 275. Responsive to determining that the first simulation based on the first modified data value is successful (e.g., the first simulation continues until reaching an expected interruption indicating a potential success in the operational plan described by the staged build plan data object 250a), the staging-simulation module 270 could generate or modify the revision data 277 to include the first modified data value. In addition, the staging-simulation module 270 could perform a second simulation of the staged build plan data object 250a based on a second modified data value described by the simulation request data 275. Responsive to determining that the second simulation based on the second modified data value fails (e.g., the second simulation stops after reaching an unexpected interruption indicating a potential failure in the operational plan described by the staged build plan data object 250a), the staging-simulation module 270 could generate or modify the revision data 277 to exclude the second modified data value. In some cases, the revision data 277 can include alert data that can be interpreted by a network node in the multi-node network 230 or a user computing system associated with the network node. For example, the revision data 277 could include alert data that describes the successful first simulation based on the first modified data value or the failed second simulation based on the second modified data value.

In some cases, the staging-simulation module 270 (or another component of the multi-party operational plan simulation computing system 210) can generate the revision data 277 based on feedback data, such as feedback data that describes a result of a real-world (e.g., not simulated) implementation of the operational plan described by the build plan data object 250. Examples of feedback data can include accounting data (e.g., sales results, profit/loss ratios), milestone data describing achieved or missed goals in the operational plan (e.g., a product manufacturing target that is achieved or missed), performance data describing comparative performance of the operational plan (e.g., simulated performance compared to real-world performance), personnel data describing changes to participants for the operation plan (e.g., a party that commits to or exits a role), or other types of feedback data that describe a real-world implementation of an operational plan described by a build plan data object. In some cases, feedback data can describe interruptions in a real-world implementation of an operational plan, such as an expected interruption (e.g., a holiday break) or an unexpected interruption (e.g., shipping disruptions caused by weather). In some cases, the multi-party operational plan simulation computing system 210 could receive feedback data from one or more additional computing systems, such as the user computing systems 290 or 280 or an additional computing system configured to provide feedback data (e.g., via an application programming interface). Responsive to receiving the feedback data, the staging-simulation module 270 could identify one or more data values related to the feedback data, such as a data value in the data objects 250 or 260. In addition, the staging-simulation module 270 could generate or modify the revision data 277 to include a recommendation value for the identified data value. In some cases, the revision data 277 can include alert data that describes the feedback data, such as alert data indicating the result of the real-world implementation of the operational plan described by the build plan data object 250.

In FIG. 2, the staging-simulation module 270 could provide one or more of the simulation results data 273, the interruption data 279, or the revision data 277 to one or more network nodes having a participant role for the build plan data object 250, such as the network node 235a or the network node 235b. In response to receiving the data 273, 279, or 277, the network nodes 235a and 235b could respectively configure user interfaces of the user computing system 290 (associated with the network node 235a) and the user computing system 280 (associated with the network node 235b). In some cases, one or more network nodes having a participant role for the build plan data object 250 could select a subset of information for presentation via a respective user interface, based on a particular participant role associated with a particular one of the network nodes. For example, based on the network node 235a having an ownership role or an entrepreneurial role for the build plan data object 250, the network node 235a could select for presentation a relatively large subset of information from the data 273, 279, or 277. The network node 235a could configure a first user interface of the associated user computing system 290 to present the simulation outcomes or simulation comparisons based on the simulation results data 273. In addition, the network node 235a could configure the first user interface to present the expected or unexpected interruptions based on the interruption data 279. In addition, the network node 235a could configure the first user interface to present the first or second modified data values, the recommendation value related to the feedback data, or the alert data based on the revision data 277. In addition, based on the network node 235b having a consultant role or a financial role for the build plan data object 250, the network node 235b could configure a second user interface of the associated user computing system 280 to present a relatively small subset of information from the data 273, 279, or 277, such as a subset of information that is related to the participant role of the network node 235b.

In the multi-party operational plan simulation computing system 210, the build-simulation module 240 can generate revised characteristic data 245. The revised characteristic data 245 can describe one or more proposed modifications associated with the build plan data object 250, such as proposed modifications to the build plan data object 250 or the parameter data object 260. In addition, the build-simulation module 240 can generate the revised characteristic data 245 based on simulation information data that describes simulation of the staged build plan data object 250a, such as the revision data 277. In some cases, the build-simulation module 240 can the build-simulation module 240 can generate the revised characteristic data 245 based on input data received from one or more network nodes having a participant role for the build plan data object 250. For example, the build-simulation module 240 could receive input data 295 from the user computing system 290 and via the network node 235a. In addition, the build-simulation module 240 could receive input data 285 from the user computing system 280 and via the network node 235b. The input data 295 can describe a first modification associated with the build plan data object 250. The input data 285 can describe a second modification associated with the build plan data object 250. Examples of modifications associated with the build plan data object 250 can include one or more modifications for the operational characteristic data 255 in the build plan data object 250, the parameter data 265 in the parameter data object 260, the staged data objects 250a or 260a, or other data structures associated with the build plan data object 250.

Based on one or more of the revision data 277, the input data 295, or the input data 285, the build-simulation module 240 generates revised characteristic data 245. The revised characteristic data 245 can be based on the potential revision described by the revision data 277 (e.g., the first or second modified data values, the recommendation value based on the feedback data). In addition, the revised characteristic data 245 can be based on the first and second modifications described by the input data 295 and 285. In some cases, the build-simulation module 240 determines that the first modification described by the input data 295 and the second modification described by the input data 285 are non-identical. Examples of non-identical modifications could include data describing different modified values for a particular operational characteristic or parameter, data describing non-overlapping (e.g., disjoint) or partially overlapping ranges for a particular operational characteristic or parameter, data describing deletion or inclusion for a particular operational characteristic or parameter, or other types of modifications that would cause non-identical values for a modified data value associated with the build plan data object 250. In response to determining that the first modification and the second modification are non-identical, the build-simulation module 240 can generate the revised characteristic data 245 based on one or more potential combinations of the first and second modifications, such as a combined range of data values, an average data value, a list of data values proposed by the first and second modifications, or other combinations of data described by the first and second modifications. In some cases, build-simulation module 240 can generate the revised characteristic data 245 based on one or more potential combinations of the revision data 277, the first modification, or the second modification. In some cases, the build-simulation module 240 can modify the one or more of the build plan data object 250 or the parameter data object 260 based on the revised characteristic data 245.

In FIG. 2, the build-simulation module 240 can provide the revised characteristic data 245 to one or more network nodes having a participant role for the build plan data object 250, such as the network node 235a or the network node 235b. In response to receiving the revised characteristic data 245, the network nodes 235a and 235b could respectively configure user interfaces of the user computing system 290 (associated with the network node 235a) and the user computing system 280 (associated with the network node 235b). For example, the respective user interfaces can be configured to present information described by the revised characteristic data 245, such as the proposed first and second modifications, the potential combinations of the first and second modifications, respective sources of the first and second modifications (e.g., parties respectively associated with the network nodes 235a and 235b), respective participant roles associated with the first and second modifications, or other information related to the revised characteristic data 245. In addition, the network nodes 235a and 235b can be configured to receive, from the respective user computing systems 290 and 280, selection data that indicates one or more portions of the revised characteristic data 245. In some cases, one or more of the network nodes 235a or 235b could weight the respective selection data, such as a weight that is based on a participant role of a particular network node. For example, the network node 235a could receive first selection data from the user computing system 290, indicating a first portion of the revised characteristic data 245. Based on a first participant role associated with the network node 235a, such as an ownership role, the network node 235a could weight the first selection data to have a relatively increased value, e.g., an increased voting weight accorded to an owner of the operational plan described by the build plan data object 250. In addition, the network node 235b could receive second selection data from the user computing system 280, indicating a second portion of the revised characteristic data 245. Based on a second participant role associated with the network node 235b, such as a consultant role, the network node 235b could weight the second selection data to have a relatively decreased value, e.g., a decreased voting weight accorded to a consultant on the operational plan described by the build plan data object 250.

Based on the selection data or the weighted selection data, the build-simulation module 240 can generate consensus modification data 247. The consensus modification data 247 can describe a consensus modification to the build plan data object 250 (or an associated data structure), such as a modification that is determined by the build-simulation module 240. For example, the build-simulation module 240 could determine the consensus modification based on a combination of weighted selection data received from multiple network nodes having a participant role for the build plan data object 250. In addition, the build-simulation module 240 could generate the consensus modification data 247 based on a portion, or combination of portions, of the revised characteristic data 245 indicated by the selection data. For example, the build-simulation module 240 could generate the consensus modification data 247 based on a particular portion of the revised characteristic data 245 having a highest proportion of weighted selection data (e.g., a highest amount of votes by parties having participant roles). In addition, the build-simulation module 240 could generate the consensus modification data 247 based on a combination of portions of the revised characteristic data 245, such as a weighted average that is determined based on weighted selection data.

In some cases, the build-simulation module 240 can modify one or more of the build plan data object 250 or the parameter data object 260 based on the consensus modification data 247. For example, the consensus modification data 247 could describe one or more modified data values, such as for a data value in the operational characteristic data 255 or a data value in the parameter data 265. Based on the consensus modification data 247, the build-simulation module 240 can modify one or more of the operational characteristic data 255, the parameter data 265, or additional data structures related to the build plan data object 250. In some cases, the build-simulation module 240 may generate interface data that can configure a user interface to present information describing the modification. The build-simulation module 240 can provide the interface data to one or more network nodes having a participant role for the build plan data object 250, such as the network nodes 235a or 235b. In some cases, additional real-world implementation of the described operational plan (e.g., subsequent to the update) can be performed based on the updated versions of the build plan data object 250 or the parameter data object 260. Furthermore, the staging-simulation module 270 can update one or more of the staged build plan data object 250a or the staged parameter data object 260a based on the modification of the build plan data object 250 or parameter data object 260. In addition, additional simulations of the staged build plan data object 250a (e.g., subsequent to the update) could be performed based on the updated versions of the staged data objects 250a and 260a, such as in response to additional simulation request data that describes a requested modification to the updated versions.

In some cases, the multi-party operational plan simulation computing system 210 is configured to record interactions with the build plan data object 250 or the parameter data object 260 in a build-specific interaction ledger, such as generally described in regard to FIG. 1. For example, the multi-party operational plan simulation computing system 210 could include a build-specific interaction ledger that is associated with the build plan data object 250. In addition, the multi-party operational plan simulation computing system 210 could record, in the associated build-specific interaction ledger, data records that describe modifications, simulation requests, simulations, data generated based on simulations or requested simulations (e.g., simulation results data, interruption data, revision data), access requests, providing or revoking a participant relationship, consensus modification data, selection data received from one or more network nodes having a participant role, or other types of interactions with the build plan data object 250 or data objects associated with the build plan data object 250 (e.g., the parameter data object 260, the staged data objects 250a or 260a).

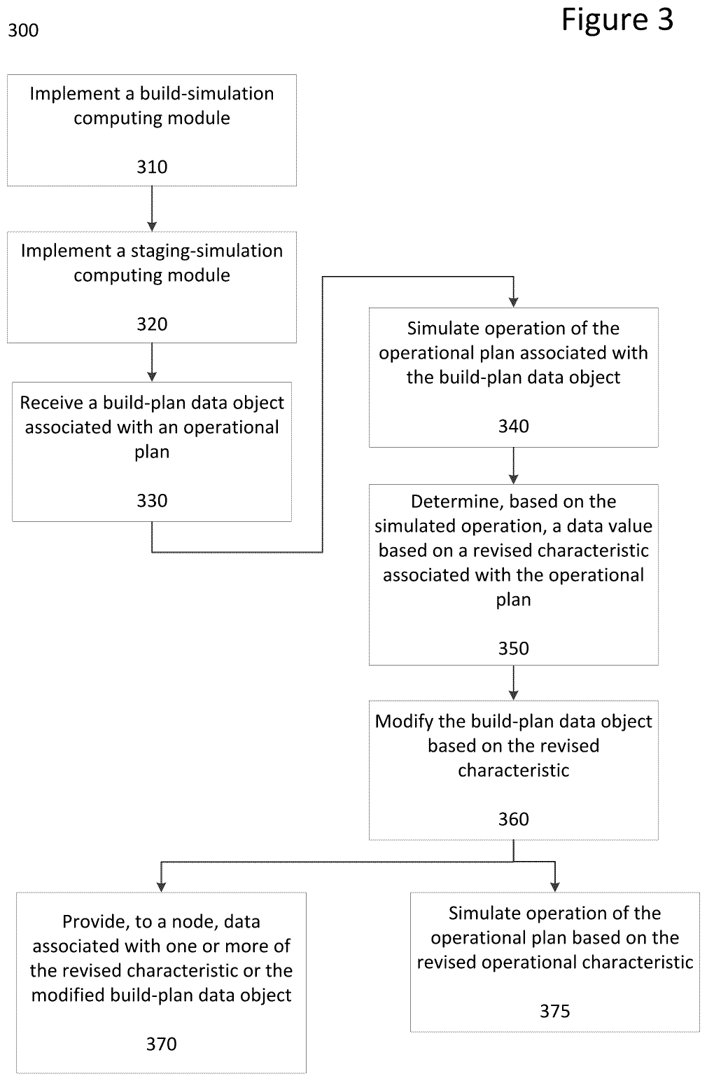

FIG. 3 is a flow chart depicting an example of a process 300 for performing computer-simulated implementation of an operational plan. In some embodiments, such as described in regards to FIGS. 1-2, a computing device executing a multi-party operational plan simulation computing system executes instructions for techniques described in FIG. 3, by executing suitable program code. For illustrative purposes, the process 300 is described with reference to the examples depicted in FIGS. 1-2. Other configurations, however, are possible.

At block 310, the process 300 involves implementing a build-simulation module. The build-simulation module can be included in a multi-party operational plan simulation computing system. In addition, the build-simulation module is accessible by (or otherwise associated with) a first network node in an multi-node network of the multi-party operational plan simulation computing system. In some cases, the build-simulation module is configured for generating one or more build plan data objects, such as a build plan data object that is based on operational characteristics of an operational plan. The first network node can have, for example, a participant role for the one or more build plan data objects that are generated by the build-simulation module. For example, the multi-party operational plan simulation computing system 210 can implement the build-simulation module 240 accessible by the network node 235a. In addition, the build-simulation module 240 can generate the build plan data object 250, such as based on input data received via the network node 235a or an additional network node having a participant role for the build plan data object 250. The build plan data object 250 can include the operational characteristic data 255, which describes operational characteristics of the operational plan that is described by the build plan data object 250. In some cases, the build-simulation module is configured for generating one or more parameter data objects, such as a parameter data object that is based on simulation characteristics of a simulation environment for an operational plan. For example, the build-simulation module 240 can generate the parameter data object 260 that describes a simulation environment for the operational plan described by the build plan data object 250.

At block 320, the process 300 involves implementing a staging-simulation module. The staging-simulation module can be included in the multi-party operational plan simulation computing system. In addition, the staging-simulation module is accessible by multiple network nodes in the multi-node network of the multi-party operational plan simulation computing system, such as the first network node and a second network node. In some cases, the staging-simulation module is configured for simulating one or more simulated environments, such as a simulated environment for the build plan data object generated by the build-simulation module. For example, the staging-simulation module 270 can be configured to generate one or more simulation environments for the build plan data object 250. In addition, the staging-simulation module 270 can be accessible by multiple ones of the network nodes 235a through 235n. For example, the staging-simulation module 270, or the staged data objects 250a or 260a, could be accessed by the network node 235n which is denied access to the build-simulation module 240 and the data objects 250 and 260 (e.g., the network node 235n does not have a participant role for the build plan data object 250). In some cases, the staging-simulation module implements a particular simulated environment for a particular build plan data object, but other configurations are possible, such as an staging-simulation module that implements a particular simulated environment for multiple build plan data objects, or multiple simulated environments for a particular build plan data object.

At block 330, the process 300 involves receiving one or more build plan data objects, or associated parameter data objects. For example, the staging-simulation module could receive the build plan data object that is generated by the build-simulation module. In addition, the staging-simulation module could receive the parameter data object that is associated with the build plan data object. The received build plan data object can describe (or otherwise be associated with) operational characteristics of the operational plan. In some cases, the staging-simulation module can generate a staged build plan data object and a staged parameter data object that are based on the received build plan data object and associated parameter data object. In addition, the staging-simulation module can generate the simulated environment based on the staged data objects. For example, the staging-simulation module 270 can receive, or otherwise access, one or more of the build plan data object 250 or the parameter data object 260 from the build-simulation module 240. Based on the data objects 250 and 260, the staging-simulation module 270 can generate the staged build plan data object 250a and the staged parameter data object 260a. In addition, the staging-simulation module 270 can implement one or more simulation environments based on the staged data objects 250a and 260a (or modifications thereof). For example, the staging-simulation module 270 can generate a simulation environment for the build plan data object 250 based on the staged data objects 250a and 260a.

At block 340, the process 300 involves simulating operation of the operational plan described by the build plan data object. The staging-simulation module, for example, can simulate operation of the operational plan within the simulated environment, based on one or more of the staged build plan data object or the staged parameter data object. In some cases, the staging-simulation module simulates operation in response to receiving simulation request data. For example, the staging-simulation module could receive simulation request data from one or more network nodes in the multi-node network of the multi-party operational plan simulation computing system, such as from a network node that has access to the build-simulation module (e.g., has a participant role for the build plan data object), an additional network node that is denied access to the build-simulation module (e.g., does not have a participant role for the build plan data object), or from multiple network nodes. In some cases, the simulation request data describes one or more modifications to the operational plan or the simulated environment. For example, the staging-simulation module 270 could receive the simulation request data 275, such as from at least one of the network nodes 235a through 235n. In addition, the simulation request data 275 could describe one or more modifications to the staged build plan data object 250a or the staged parameter data object 260a. The staging-simulation module 270 can modify the staged data objects 250a or 260a (or generate additional versions that include the modifications) based on the simulation request data 275. In addition, the staging-simulation module can simulate the operational plan (e.g., described by the build plan data object 250) based on the staged data objects 250a and 260a, or modifications thereof. In some cases, the staging-simulation module generates one or more types of simulation information data that describe the simulation or outcomes of the simulation. For example, the staging-simulation module 270 can generate one or more of the simulation results data 273, the interruption data 279 or the revision data 277 based on simulation of the staged data objects 250a and 260a, or modifications thereof.

At block 350, the process 300 involves determining a data value based on the simulated operation of the operational plan. In addition, the data value can based on a revised characteristic that is associated with the operational plan, such as a revised operational characteristic of the operational plan or a revised simulation characteristic of the simulated environment for the operational plan. In some cases, the revised characteristic can be determined by the build-simulation module (or another component of the multi-party operational plan simulation computing system) based on revision data generated by the staging-simulation module. For example, the build-simulation module 240 could generate the revised characteristic data 245 based on the revision data 277. In addition, the revised characteristic can be determined by the build-simulation module (or another component of the multi-party operational plan simulation computing system) based on input data received from one or more network nodes that are associated with the build plan data object, such as one or more network nodes that have participant roles for the build plan data object. For example, the build-simulation module 240 could generate the revised characteristic data 245 based on the input data 295 and 285 received via the network nods 235a and 235b. In some cases, the multi-party operational plan simulation computing system can generate consensus modification data for the build plan data object or associated parameter data object based on the data value.

At block 360, the process 300 involves modifying one or more of the build plan data object or the associated parameter data object based on the revised characteristic, such as one or more of the revised operational characteristic or the revised simulation characteristic. In some cases, the build-simulation module can modify the build plan data object to include the revised operational characteristic. In addition, the build-simulation module can modify the parameter data object to include the revised simulation characteristic. For example, the build-simulation module 240 can modify one or more of the build plan data object 250 or the parameter data object 260 based on the revised characteristic data 245. In addition, the build-simulation module 240 can modify one or more of the build plan data object 250 or the parameter data object 260 based on the consensus modification data 247, which is determined based on, for example, selection data or weighted selection data indicating a portion of the revised characteristic data 245.

At block 370, the process 300 involves providing interface data, such as descriptive data that can configure a user interface, to one or more nodes associated with the build plan data object. The interface data can be based on one or more of the revised characteristic data, the modified build plan data object, the modified parameter data object, or data values or structure associated with the modified build plan data object. In some cases, the build-simulation module can provide the user interface data to a group of network nodes in the multi-node network, based on a determination that each network node in the group has a participant role for the build plan data object. based on the interface data, each network node in the group can configure a user interface of an associated user computing system. For example, the build-simulation module 240 can provide interface data to the network nodes 235a and 235b, based on a determination that the network nodes 235a and 235b have respective participant roles for the build plan data object 250. In addition, each of the network nodes 235a and 235b can configure a respective user interface based on the interface data, such as respective user interfaces of the user computing systems 290 and 280.

At block 375, the process 300 involves simulating operation of the operational plan described by the modified build plan data object, based on the revised characteristic. In some cases, the build-simulation module can provide one or more of the revised characteristic data, the modified build plan data object, or the modified parameter data object to the staging-simulation module. In addition, the staging-simulation module can modify one or more of the staged build plan data object or the staged parameter data object. In some cases, the staging-simulation module can simulate the modified staged build plan data object in response to receiving the revised characteristic data or modified data object from the build-simulation module. In some cases, the staging-simulation module can simulate the modified staged build plan data object in response to receiving additional simulation request data, such as from a network node requesting simulation of the operational plan as modified.

In some cases, one or more operations of the process 300 can be performed is various sequences, or simultaneously. For example, the multi-party operational plan simulation computing system could perform operations related to block 375, e.g., simulating the modified build plan data object, prior to, or in parallel with, operations related to block 370, e.g., providing interface data to one or more nodes associated with the build plan data object.

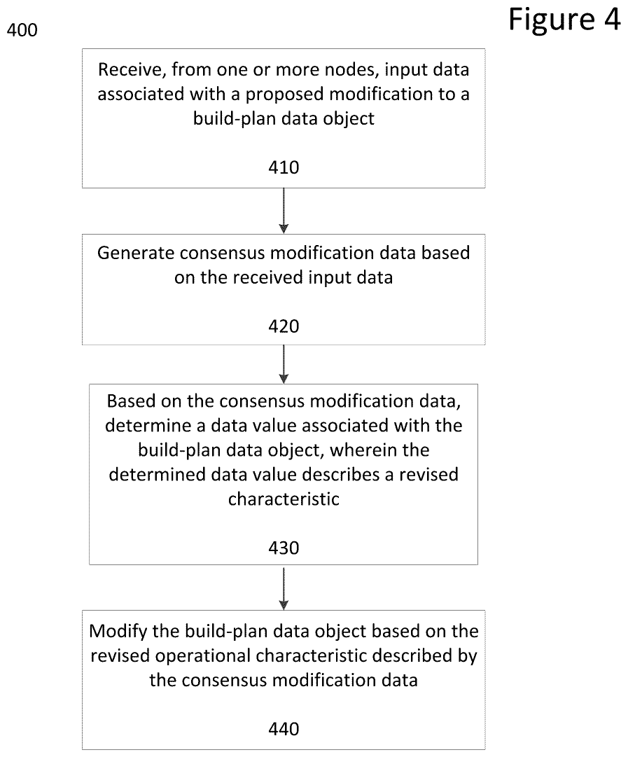

FIG. 4 is a flow chart depicting an example of a process 400 for generating consensus modification data for a revised characteristic associated with computer-simulated implementation of an operational plan. In some embodiments, such as described in regards to FIGS. 1-3, a computing device executing a multi-party operational plan simulation computing system executes instructions for techniques described in FIG. 4, by executing suitable program code. For illustrative purposes, the process 400 is described with reference to the examples depicted in FIGS. 1-3. Other configurations, however, are possible.

At block 410, the process 400 involves receiving input data that is based on one or more proposed modifications to a build plan data object. A build-simulation module included in a multi-party operational plan simulation computing system can receive the input data. In addition, the build-simulation module can receive the input data from one or more network nodes that are included in a multi-node network of the multi-party operational plan simulation computing system, such as a group of participant nodes that have respective participant roles for the build plan data object. In some cases, one or more of the participant nodes can provide respective input data that describes a respective proposed modification. For example, the build-simulation module 240 can receive, via the network node 235a and the network node 235b, the input data 295 and the input data 285. In addition, the input data 295 and the input data 285 can describe respective proposed modifications to the build plan data object 250, such as non-identical proposed modifications based on different data values, non-overlapping or partially overlapping ranges for data values, or other types of proposed modifications.

At block 420, the process 400 involves generating consensus modification data based on the received input data. The consensus modification data can describe a consensus modification to the build plan data object, such as a consensus value for a revised characteristic associated with the build plan data object. In some cases, the build-simulation module can generate the consensus modification data based on selection data or weighted selection data that is received from one or more of the participant nodes that have respective participant roles for the build plan data object. In addition, the build-simulation module can generate the consensus modification data based on one or more portions of the proposed modifications described by the input data. For example, the build-simulation module 240 could generate the revised characteristic data 245 based on a combination of the input data 295 and 285. In addition, the build-simulation module could receive, via the network node 235a and the network node 235b, respective selection data. The respective selection data can indicate a respective portion of the revised characteristic data 245, such as a first portion indicated by the selection data from the network node 235a and a second portion indicated by the selection data from the network node 235b. In some cases, the build-simulation module 240 can determine one or more weights associated with the selection data, such as a particular weight that is based on a participant role of a particular participant node for the build plan data object 250. In addition, the build-simulation module 240 can generate the consensus modification data 247 based on the selection data (or weighted selection data) and the indicated portions of the revised characteristic data 245.

At block 430, the process 400 involves determining, based on the consensus modification data, one or more data values associated with the build plan data object. In some cases, the build-simulation module can determine a particular data value that is based on a revised characteristic, such as a revised characteristic indicated by the consensus modification data. In addition, the build-simulation module can modify or generate the particular data value based on the consensus modification data. For example, the build-simulation module 240 could determine a data value (e.g., in the operational characteristic data 255 or the parameter data 265) based on a modification that is described by the consensus modification data 247. In addition, the build-simulation module 240 could modify (or generate) the data value to include the described modification, such as modifying the data value to include a numeric value (or other data element) that is indicated by the consensus modification data 247.

At block 440, the process 400 involves modifying the build plan data object based on the consensus modification data, such as a modification that is based on one or more revised characteristics described by the consensus modification data. In some cases, the build-simulation module can modify the build plan data object (or an associated parameter data object) to include the data value that was determined based on the consensus modification data. For example, the build-simulation module 240 can modify one or more of the build plan data object 250 or the parameter data object 260 based on the consensus modification data 247. In some cases, the build-simulation module 240 could modify a data value in the operational characteristic data 255 based on a revised operational characteristic that is described by the consensus modification data 247. In addition, the build-simulation module 240 could modify a data value in the parameter data 265 based on a revised simulation characteristic that is described by the consensus modification data 247. In some cases, a staging-simulation module included in the multi-party operational plan simulation computing system can modify one or more of an associated staged build plan data object or an associated staged parameter data object in response to determining that the build plan data object or the associated parameter data object is modified based on the consensus modification data. For example, the staging-simulation module 270 could modify one or more of the staged data objects 250a or 260a based on a determination that one or more of the data objects 250 or 260 is modified based on the consensus modification data 247.

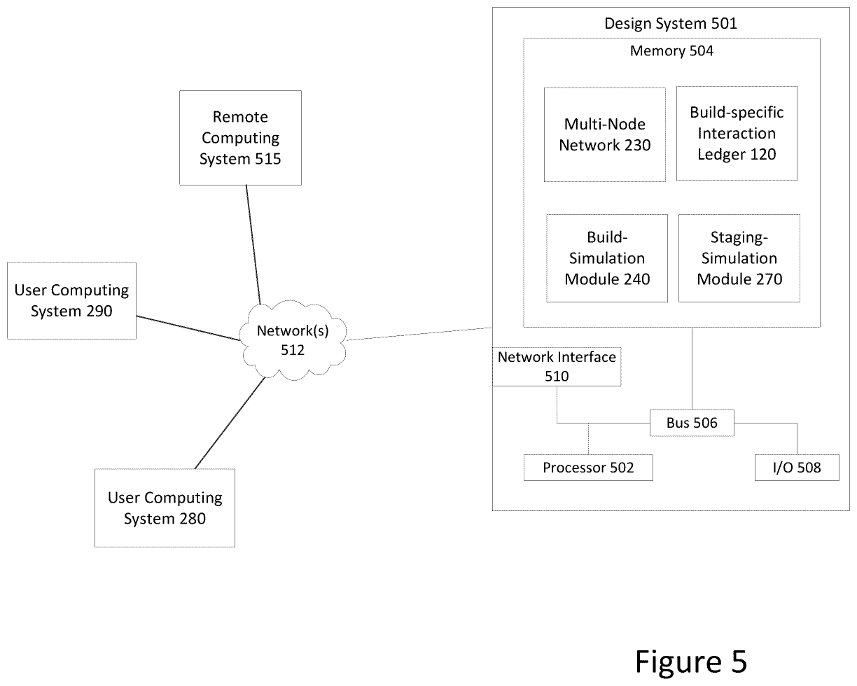

Any suitable computing system or group of computing systems can be used for performing the operations described herein. For example, FIG. 5 is a block diagram depicting a computing system 501 configured to implement a multi-party operational plan simulation computing system, according to certain embodiments. The computing system 501 can be configured to implement the multi-party operational plan simulation computing system 110, the multi-party operational plan simulation computing system 210, or other embodiments described herein.

The depicted example of a computing system 501 includes one or more processors 502 communicatively coupled to one or more memory devices 504. The processor 502 executes computer-executable program code or accesses information stored in the memory device 504. Examples of processor 502 include a microprocessor, an application-specific integrated circuit (“ASIC”), a field-programmable gate array (“FPGA”), or other suitable processing device. The processor 502 can include any number of processing devices, including one.

The memory device 504 includes any suitable non-transitory computer-readable medium for storing the multi-node network 130, the build-simulation module 240, the staging-simulation module 270, the build-specific interaction ledger 120, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 501 may also include a number of external or internal devices such as input or output devices. For example, the computing system 501 is shown with an input/output (“I/O”) interface 508 that can receive input from input devices or provide output to output devices. A bus 506 can also be included in the computing system 501. The bus 506 can communicatively couple one or more components of the computing system 501.

The computing system 501 executes program code that configures the processor 502 to perform one or more of the operations described above with respect to FIGS. 1-4. The program code includes operations related to, for example, one or more of the multi-node network 130, the build-simulation module 240, the staging-simulation module 270, the build-specific interaction ledger 120, or other suitable applications or memory structures that perform one or more operations described herein. The program code may be resident in the memory device 504 or any suitable computer-readable medium and may be executed by the processor 502 or any other suitable processor. In some embodiments, the program code described above, the multi-node network 130, the build-simulation module 240, the staging-simulation module 270, and the build-specific interaction ledger 120 are stored in the memory device 504, as depicted in FIG. 5. In additional or alternative embodiments, one or more of the multi-node network 130, the build-simulation module 240, the staging-simulation module 270, the build-specific interaction ledger 120, and the program code described above are stored in one or more memory devices accessible via a data network, such as a memory device accessible via a cloud service.

The computing system 501 depicted in FIG. 5 also includes at least one network interface 510. The network interface 510 includes any device or group of devices suitable for establishing a wired or wireless data connection to one or more data networks 512. Non-limiting examples of the network interface 510 include an Ethernet network adapter, a modem, and/or the like. A remote system 515 is connected to the computing system 501 via network 512, and remote system 515 can perform some of the operations described herein, such as storing color images or extracted patches. The computing system 501 is able to communicate with one or more of the remote computing system 515 and the 3D scanning system 120 using the network interface 510. Although FIG. 5 depicts the build-specific interaction ledger 120 as being included in the computing system 501, other embodiments are possible, such as one or more build-specific interaction ledgers executed via the remote system 515 or an additional computing system.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied-for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method of simulating operation of an operational plan, the method including operations executed by a processor, the operations comprising:
implementing a build-simulation module accessible by a first network node in a multi-node network, the build-simulation module configured to generate a build plan data object based on characteristics of an operational plan;
implementing a staging-simulation module configured to simulate an environment for the operational plan, the staging-simulation module being accessible by the first network node and a second network node in the multi-node network;
responsive to receiving simulation request data from the second network node, simulating, by the staging-simulation module, operation of the operational plan within the simulated environment;
determining, based on the simulated operation, a data value based on a revised characteristic of the operational plan;
modifying, by the build-simulation module, the build plan data object based upon the revised characteristic; and
providing, to the first network node and the second network node, interface data associated with the modified build plan data object.

2. The method of claim 1, wherein the staging-simulation module is further configured to simulate the operation of the operational plan within the simulated environment based on a simulation characteristic associated with a parameter data object.

3. The method of claim 2, wherein the build-simulation module is further configured to generate the parameter data object.

4. The method of claim 2, wherein the simulation request data is associated with a modification to the parameter data object.

5. The method of claim 1, wherein the build-simulation module is further configured to generate the build plan data object responsive to input data received via a user interface associated with the first network node.

6. The method of claim 1, the operations further comprising:
receiving, from each network node of a group of network nodes in the multi-node network, respective selection data input indicating a respective proposed modification to the build plan data object; and
based on the respective selection data input from each network node of the group of network nodes, generate consensus modification data describing a consensus modification to the build plan data object, wherein the data value describing the revised characteristic is determined based on the consensus modification data.

7. The method of claim 1, the operations further comprising modifying a distributed ledger based upon or more of: the build plan data object, the modified build plan data object, the simulated operation, or the data value associated with the revised characteristic.

8. A system comprising:
a processor, and a non-transitory computer-readable storage device storing instructions that are executable by the processor to:
implement a staging-simulation module configured to simulate an operational environment, the staging-simulation module being accessible by multiple network nodes;
receive, from a build-simulation module, a build plan data object associated with characteristics of an operational plan;
simulate, by the staging-simulation module, operation of the operational plan within the simulated operational environment;
determine, based on the simulated operation, a data value describing a revision for a characteristic associated with the operational plan; and
provide the data value to the build-simulation module.

9. The system of claim 8, wherein the staging-simulation module is further configured to simulate the operation of the operational plan within the simulated operational environment based on a simulation characteristic associated with a parameter data object.

10. The system of claim 9, wherein the build-simulation module is configured to generate the parameter data object.

11. The system of claim 9, wherein the staging-simulation module is further configured to simulate the operation of the operational plan within the simulated operational environment in response to a modification to the parameter data object.

12. The system of claim 8, wherein the build-simulation module is configured to generate the build plan data object responsive to input data received via a user interface associated with a particular network node of the multiple network nodes.

13. The system of claim 8, the instructions further executable by the processor to:
receive, from each network node of a group of network nodes in the multiple network nodes, respective input data indicating a respective proposed modification to the build plan data object; and
based on the respective input data from each network node of the group of network nodes, generate consensus modification data describing a consensus modification to the build plan data object,
wherein the data value describing the revision for the characteristic is determined based on the consensus modification data.

14. The system of claim 8, the instructions further executable by the processor to modify a distributed ledger based on one or more of: the build plan data object, the simulated operation, or the data value describing the revision for the characteristic.

15. A non-transitory computer-readable medium embodying program code for simulating operation of an operational plan, wherein, when executed by a processor, the program code causes the processor to perform operations comprising:
implementing a staging-simulation module configured to simulate an operational environment, the staging-simulation module being accessible by multiple network nodes;
receiving, from a build-simulation module, a build plan data object that associated with characteristics of an operational plan;
simulating, by the staging-simulation module, operation of the operational plan within the simulated operational environment;
determining a group of participant nodes from the multiple network nodes, each participant node in the group having a participant role for the build plan data object;
receiving, from one or more participant nodes in the group, respective input data indicating a respective proposed modification to the build plan data object;
based on the respective input data from the one or more participant nodes, generating consensus modification data describing a consensus modification to the build plan data object; and
modifying the build plan data object to include a revised characteristic based on the consensus modification data.

16. The non-transitory computer-readable medium of claim 15, wherein the staging-simulation module is further configured to simulate the operation of the operational plan within the simulated operational environment based on a simulation characteristic associated with a parameter data object.

17. The non-transitory computer-readable medium of claim 16, wherein the build-simulation module is configured to generate the parameter data object.

18. The non-transitory computer-readable medium of claim 16, wherein the staging-simulation module is further configured to simulate the operation of the operational plan within the simulated operational environment in response to a modification to the parameter data object.

19. The non-transitory computer-readable medium of claim 15, wherein the build-simulation module is configured to generate the build plan data object responsive to input data received via a user interface associated with a particular node of the multiple network nodes.

20. The non-transitory computer-readable medium of claim 15, the operations further comprising modifying a distributed ledger based on one or more of: the build plan data object, the modified build plan data object, the simulated operation, the consensus modification data, or the revised characteristic.
